(19) United States
(12) Patent Application Publication
(10) Pub. No.: US 2016/0143057 A1
(43) Pub. Date: May 19, 2016

(54) METHOD AND NETWORK NODE FOR MANAGING COLLISIONS

(71) Applicant: TELEFONAKTIEBOLAGET L M ERICSSON (PUBL), Stockholm (SE)

(72) Inventors: Gen LI, BEIJING (CN); Rui FAN, Beijing (CN)

(73) Assignee: Telefonaktiebolaget L M Ericsson (publ), Stockholm (SE)

(21) Appl. No.: 14/897,109

(22) PCT Filed: Jul. 2, 2013
(86) PCT No.: PCT/CN2013/078683

§ 371 Date: Dec. 9, 2015

(51) Int. Cl. H04W 74/08; H04W 48/06; H04W 4/06

(52) U.S. Cl. CPC H04W 74/085; H04W 4/06; H04W 48/06

(57) ABSTRACT

It is presented a method for managing collisions in a cell of a cellular communication network comprising a radio access network shared by a plurality of core network operators, each core network operator being associated with a priority. The method is performed in a network node and comprises the steps of: estimating a random access load in the cell by considering successful and failed random access attempts by wireless devices during an estimation period in the cell; determining a set of restrictions for wireless devices of a lower priority operator of the multiple core network operators based on the estimated random access load; and restricting random access in the cell according to the set of restrictions. A corresponding network node is also presented.

### TECHNICAL FIELD

The technology relates to the management of collisions during random access in a cellular communication network.

### BACKGROUND

Broadband communication in cellular networks for public safety is an issue addressed by a National Broadband Nan (NBP) of the Federal Communications Commission (FCC) in USA. An operator has been appointed to establish a national public safety broadband networks (NPSBN). In order to improve spectrum efficiency and reduce the cost of the NPSBN, the operator will coordinate with commercial operators to provide sharing of the radio access network. Similar schemes are likely to appear in other countries.

An FCC white paper entitled “The Public Safety Nationwide Interoperable Broadband Network: A new Model for Capacity Performance and Cost”, available at http://transition.fcc.gov/pshs/docs/releases/DOC-298799A1.pdf at the time of filing this patent application, describes that public safety should have priority access, but does not describe how this priority is to be achieved.

Hence, one question is how, in the case of an emergency, the true public safety traffic is to be prioritised over other traffic. There are prioritisation mechanisms available in the prior art, but these are complicated and need to be applied on a per user basis.

### SUMMARY

An object is to provide a way to prioritise between a plurality of core network operators sharing one radio access network.

According to a first aspect, it is presented a method for managing collisions in a cell of a cellular communication network comprising a radio access network shared by a plurality of core network operators, each core network operator being associated with a priority. The method is performed in a network node and comprises the steps of: estimating a random access load in the cell by considering successful and failed random access attempts by wireless devices during an estimation period in the cell; determining a set of restrictions for wireless devices of a lower priority operator of the multiple core network operators based on the estimated random access load; and restricting random access in the cell according to the set of restrictions. By considering the failed and successful attempts of random access, a decent estimate of load for wireless devices of different operators is achieved. This is then used to specifically restrict random access for those wireless devices of a lower priority operator. In this way, an automatic response to higher load is achieved, whereby when random access load increases, the wireless devices of the lower priority operator traffic is restricted. When load is low, no restrictions on random access need to be applied.

The method may further comprise the step, after the step of restricting, of determining whether the random access load is higher than a threshold value, wherein the method is repeated when the random access load is higher than the threshold value, wherein each new iteration of the step of determining a set of restrictions comprises determining a set of restrictions which is stricter compared to the previous iteration. In this way, if the restrictions do not give sufficient load decrease, successively more restrictive random access is applied to the wireless devices of the lower priority operators.

The step of estimating a random access load may comprise calculating the sum of a number of successful random access attempts and a failure term, the failure term being calculated as a number of failed random access attempts multiplied by a factor two.

The step of restricting random access may comprise updating a system information block which is broadcasted in the cell. This is a convenient way of communicating the restrictions to the relevant wireless devices.

The step of estimating a random access load may comprise estimating a random access load associated with each core network operator. In this way, a more accurate load estimate is achieved.

The step of estimating may comprise detecting random access attempts in random access resources which are assigned to individual ones of the core network operators.

Each new iteration may involve increasing an estimated total load in the cell. This results in progressively more restrictive random access for the wireless devices of the lower priority operators.

According to a second aspect, it is presented a network node arranged to manage collisions in a cell of a cellular communication network comprising a radio access network shared by a plurality of core network operators, each core network operator being associated with a priority. The network node comprises: a processor; and a memory storing instructions that, when executed by the processor, cause the network node to: estimate a random access load in the cell by considering successful and failed random access attempts by wireless devices during an estimation period in the cell; determine a set of restrictions for wireless devices of a lower priority operator of the multiple core network operators based on the estimated random access load; and restrict random access in the cell according to the set of restrictions.

The network node may further comprise instructions to determine whether the random access load is higher than a threshold value, and to repeat the mentioned instructions when the random access load is higher than the threshold value, wherein each new iteration of the instructions to determine a set of restrictions comprises instructions to determine a set of restrictions which is stricter compared to the previous iteration.

The instructions to estimate a random access load may comprise instructions to calculate the sum of a number of successful random access attempts and a failure term, the failure term being calculated as a number of failed random access attempts multiplied by a factor two.

The instructions to restrict random access may comprise instructions to update a system information block which is broadcasted in the cell.

The instructions to estimate a random access load may comprise instructions to estimate a random access load associated for each core network operator.

The instructions to estimate may comprise instructions to detect random access attempts in random access resources which are assigned to individual ones of the core network operators.

The network node may comprise instructions to increase an estimated total load in the cell for each new iteration.

The network node may be in the form of a radio base station being associated with the cell.

According to a third aspect, it is presented a network node comprising: means for estimating a random access load in a cell of a cellular communication network comprising a radio access network shared by a plurality of core network operators, each network operator being associated with a priority, by considering successful and failed random access attempts by wireless devices during an estimation period in the cell; means for determining a set of restrictions for wireless devices of a lower priority operator of the multiple core network operators based on the estimated random access load; and means for restricting random access in the cell according to the set of restrictions.

The network node may further comprise means for determining whether the random access load is higher than a threshold value, and means for repeating when the random access load is higher than the threshold value, wherein each new iteration of determining a set of restrictions comprises determining a set of restrictions which is stricter compared to the previous iteration.

The means for estimating a random access load may comprise calculating the sum of a number of successful random access attempts and a failure term, the failure term being calculated as a number of failed random access attempts multiplied by a factor two.

The means for restricting random access may comprise means for updating a system information block which is broadcasted in the cell.

The means for estimating a random access load may comprise means for estimating a random access load associated with each core network operator.

The means for estimating may comprise means for detecting random access attempts in random access resources which are assigned to individual ones of the core network operators.

Each new iteration may involve increasing an estimated total load in the cell.

The word ‘plurality’ in the description and claims is to be interpreted as meaning ‘more than one’.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating an environment where embodiments presented herein can be applied;

FIG. 2 is a schematic diagram illustrating resource usage on a physical random access channel according to one embodiment;

FIG. 3 is a schematic diagram illustrating resource usage on a physical random access channel according to one embodiment;

FIGS. 4A-C are flow charts illustrating methods for managing collisions in a cell, the method being performed in a network node of FIG. 1;

FIG. 5 is a schematic diagram showing some components of the network node of FIG. 1; and

FIG. 6 is a schematic diagram showing functional modules of the network node of FIGS. 1 and 5.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

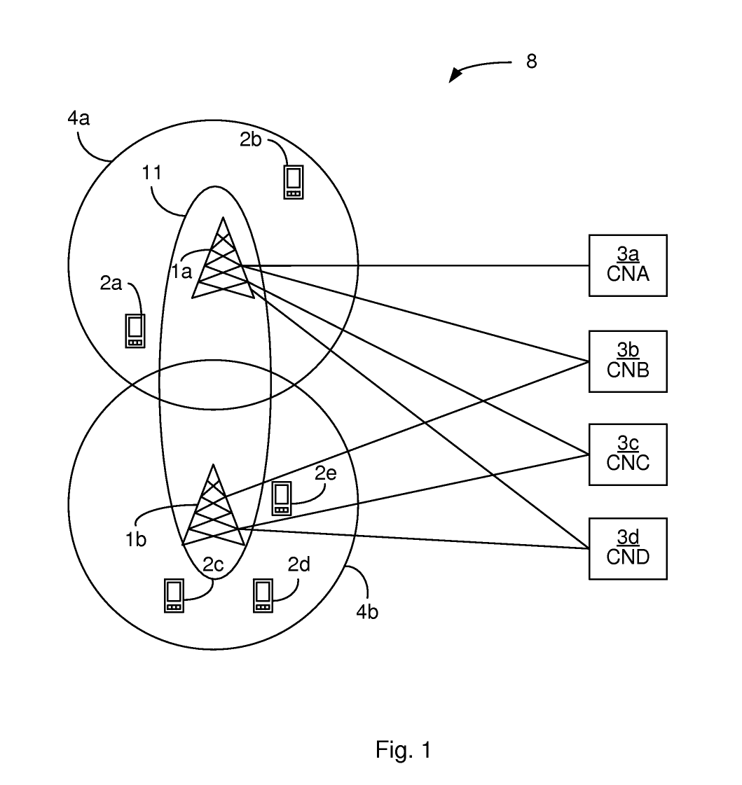

FIG. 1 is a schematic diagram illustrating an environment where embodiments presented herein can be applied. Conventionally a cellular communications network 8 comprises a radio access network (RAN) 11 and a core network. Here, however, there is a plurality of core networks 3a-d being connected to a single RAN 11. One or more of the core networks 3a-d may further be connected to one or more other RANs (not shown). Each core network 3a-d is responsible for a number of wireless devices and provide connectivity to other networks and track usage of traffic for their own billing, etc.

In this example, there is a first core network operator 3a, here denoted CNA, a second core network operator 3b, here denoted CNB, a third core network operator 3c, here denoted CNC and a fourth core network operator 3d, here denoted CND. An example using these four core networks operators 3a-d is described herein to illustrate embodiments presented herein, but it is to be noted that there may be any other number of core networks provided and with other sets of priorities than what is presented here.

In this example, the four core network operators have the following priorities:

TABLE 1
Example of operator priorities

| Core network Operator | CNA | CNB | CNC | CND |
|---|---|---|---|---|
| Priority | 1 | 2 | 2 | 3 |

In this example, a lower number implies a higher priority. Hence, CNA has the highest priority and CND has the lowest priority here, while CNB and CNC have the same, medium, priority. CNA can for example be the public safety broadband network which then has the highest priority.

As is explained in more detail below, the priorities are used to restrict random access for wireless devices belonging to lower priority networks, when required due to load. If, for instance, there is an incident such as a natural disaster, terrorist attack, etc., the load in the RAN is very likely to increase dramatically. However, due to the way the priorities are used to restrict random access, devices of the public safety operator, e.g. CNA, would be prioritised and would not be drowned by the load of the wireless devices of the other core network operators.

The RAN 11 comprises a number of network nodes 1a-b. The network nodes 1a-b, are here in the form of evolved Node Bs also known as eNBs but could also be in the form of Node Bs (NodeBs/NBs) and/or BTSs (Base Transceiver Stations) and/or BSSs (Base Station Subsystems), etc. The network nodes 1a-b provide radio connectivity to a plurality of wireless devices 2a-e. The term wireless device is also known as user equipment (UE), mobile terminal, user terminal, user agent, etc.

The first network node 1a provides coverage to a first and a second wireless device 2a-b in a first cell 4a. The second network node 1b provides coverage to a third wireless device 2c, a fourth wireless device 2d and fifth wireless device 2e in a second cell 4b. Uplink (UL) communication, from the wireless devices 2a-e to the network nodes 1a-b, and downlink (DL) communication, from the network nodes 1a-b to the wireless devices 2a-e occur over a wireless radio interface. The radio conditions of the wireless radio interface vary over time and also depend on the position of the wireless devices 2a-e, due to effects such as interference, fading, multipath propagation, etc.

The cellular communications network 8 may e.g. comply with any one or a combination of LTE (Long Term Evolution), UMTS (Universal Mobile Telecommunications System) utilising W-CDMA (Wideband Code Division Multiplex), CDMA2000 (Code Division Multiple Access 2000), or any other current or future wireless network, as long as the principles described hereinafter are applicable. Nevertheless, LTE will be used below to fully illustrate a context in which embodiments presented herein can be applied.

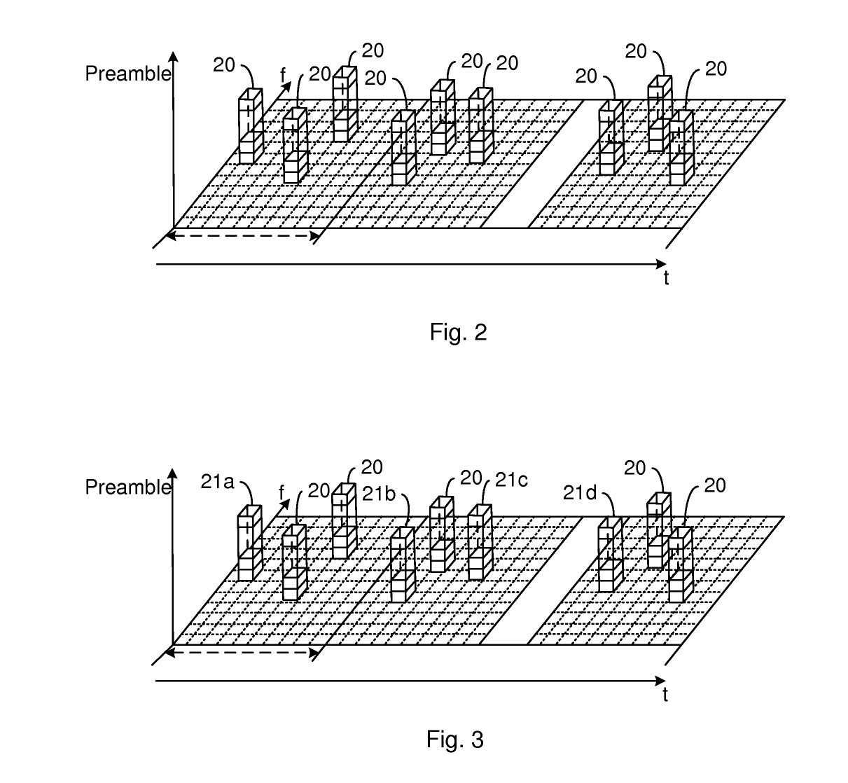

FIG. 2 is a schematic diagram illustrating resource usage on a physical random access channel according to one embodiment.

A fundamental requirement for any cellular communication network is the possibility for a wireless device to initiate a connection setup, commonly referred to as random access. Either a contention based or a contention free scheme can be used. Contention free random access can only be used for re-establishing uplink synchronisation upon downlink data arrival, handover, and positioning. The focus here, however, lies on the contention based scheme for initial access when establishing a radio link (e.g. moving from an RRC_IDLE state to an RRC_CONNECTED state). The first step in the random access procedure is a transmission of a random access preamble. The main purpose of the preamble transmission is to indicate the presence of a random access attempt to the network node 1a/1b and to allow the network node 1a/1b to estimate the delay between the wireless device and the network node 1a/1b. The delay estimate is later used to adjust uplink timing.

The timeifrequency resource on which the random access preamble is transmitted is known as the Physical Random-Access Channel (PRACH). The network broadcasts a system information block to all wireless devices, defining in which time-frequency resources random access preamble transmission is allowed (i.e. the PRACH resources). FIG. 2 illustrates an example of the allowed time-frequency resources 20 for random access of wireless devices. The horizontal axis represents time and the depth axis represents frequency. Besides these two dimensions, there is another dimension being preamble sequences, which is represented by the vertical axis. When a wireless device initiates random access, the wireless device randomly selects one of the available preambles. In each cell, there are 64 preamble sequences available. Two subsets of the 64 sequences are defined for contention-based random access attempt, which is signaled in the broadcasted system information. However, there is a certain probability of contention, i.e. multiple wireless devices using the same random access preamble at the same time. In this case, multiple wireless devices will transmit on the same uplink resource and a collision occurs. The risk of collision increases with more wireless devices attempting to perform random access in the same cell at the same time.

Under certain circumstances, access control will be needed to prevent wireless devices from making access attempts. For example, if a large amount of wireless devices want to access the network via random access in the same subframe, all the random access would probably fail due to that interference between wireless devices are too high. Access control is one way to alleviate this problem.

To implement access control, all wireless devices are categorised into different access classes. All wireless devices are members of one out of ten randomly allocated mobile populations, i.e. access classes 0 to 9, which stored in the SIM/USIM (Subscriber Identity Module/Universal Subscriber Identity Module). In addition, wireless devices may belong to one or more out of 5 special categories (access classes 11 to 15), also held in the SIM/USIM, which can be used for prioritisation within a core network operator. Broadcast messages, on a cell by cell basis, indicates the class(es) or categories of subscribers which are barred from network access. If the wireless device is a member of at least one access class which corresponds to the permitted classes as signaled over the air interface, it is allowed to attempt random access.

For UTRAN (UMTS Terrestrial Radio Access Network) in W-CDMA, the barring of access class is controlled by on/off switching for each access class. For E-UTRAN (Evolved UTRAN), the serving network broadcasts mean durations of access control and barring rates (e.g. percentage value) that commonly applied to access classes 0-9 to the wireless device. Then the wireless device draws a uniform random number between 0 and 1 when initiating connection establishment and compares with the current barring rate to determine whether it is barred or not.

In the case of multiple core networks sharing the same access network, the access network shall be able to apply access class barring for the different core networks individually.

FIG. 3 is a schematic diagram illustrating resource usage on a physical random access channel according to one embodiment. In this embodiment, in order to obtain a load ratio situation of different operators in shared RAN, each PRACH resource is configured either as a shared resource (such as all resources are in the example shown in FIG. 2) or a resource which is specific for one core network operator. The resource which is specific for one core network operator is broadcasted in the system information.

In the example shown in FIG. 3, there are five time frequency resources 20 which are shared resources. There is further one resource 21a for the first core network operator CNA, one resource 21b for the second core network operator CNB, one resource 21c for the third core network operator CNC, and one resource 21d for the fourth core network operator CND. There can be other configurations where there is a plurality of specific time-frequency resources for one or more of the core network operators. Moreover, the resources which are specific for core network operators can be defined in any suitable way within the three dimensions of time, frequency and preamble, as long as they are distinguishable from each other.

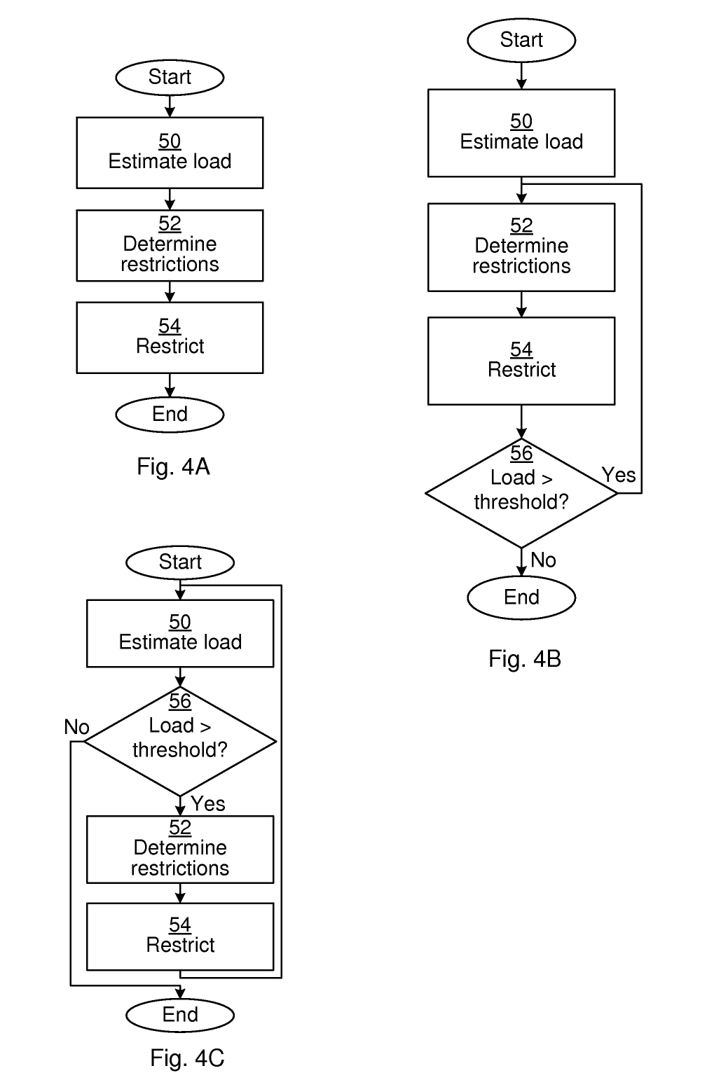

FIGS. 4A-C are flow charts illustrating methods for managing collisions in a cell, the method being performed in a network node of FIG. 1. The methods are related to managing collisions in a cell of the cellular communication network (8 of FIG. 1) where one RAN is shared by a plurality of core network operators. The method is performed for one cell and may be performed in parallel for a plurality of cells of the RAN.

In an estimate load step 50, a random access load in the cell is estimated by considering successful and failed random access attempts by wireless devices during an estimation period in the cell.

First, an estimation of total load in the cell will be explained. This is based on the observation of successful or collision attempts of random access detected at the network node. The collision may occur when two wireless devices transmit the same preamble in the same PRACH resource. Then the load can be calculated based on the collision observed by network node.

For example, there may be approximately at maximum L*M orthogonal opportunities for random access in the subframe with random access zone scheduled, where L is the number of PRACH resources in the subframe and M is the number of contention-based preambles (e.g. L=1, M=50). The base station can be able to observe the state of each opportunity: empty (i.e. no wireless device transmits), normal (i.e. one wireless device detected) or collision (i.e. two or more wireless devices transmit). During each subframe (or other estimation period), the times for empty, normal and collision are stored as N_empty, N_normal and N_collision (N_empty+N_normal+N_collision=L*M). Assuming the collision occurs only due to simultaneous preamble transmission of two wireless devices, a load can be estimated to N_normal+2*N_collision and an overload ratio E can be estimated to (N_normal+2*N_collision−L*M)/(N_normal+2*N_collision), which is defined as the ratio of the number of wireless devices exceeding the capacity for accessing attempt. The load or overload ratio indicator over an estimated time period (e.g. 8 oms which is the information update period for SIB2 (System Information Block 2)) can be the average or maximum one among multiple subframes.

Hence, the estimating of a random access load can comprise calculating load as the sum of a number of successful random access attempts (N_normal) and a failure term, the failure term being calculated as a number of failed random access attempts multiplied by a factor two (N_collision*2).

The total overload ratio E is calculated as explained above. Optionally, a margin E_{margin} can be added to E.

Optionally, a random access load associated with each core network operator is estimated. In one embodiment, random access attempts in random access resources which are assigned to individual ones of the core network operators are detected, as explained above with reference to FIG. 3.

A calculation of load in this situation will now be explained. It is assumed that there are multiple operators with different priorities, i.e. {O_{p,i}, p=1,2, . . . , P;i=1,2, . . . , Nₚ}, where O_{p,I}, is the ith operator in priority level p (e.g. O_{2,2}=CNC in Table 1), P is the total number of priority levels (e.g. P=3 in Table 1) and Nₚ is the number of operators in priority level p (e.g. N₂=2 in Table 1). Note here smaller number means higher priority, i.e. the operator with priority level 1 always has the highest priority, but the same principles can be applied with a higher priority level being indicated with a greater number. If the total collision rate in all the PRACH zone exceeds a threshold, the following adaptive access control scheme operated in base station is triggered to solve the collision problem:

Based on the occupancy and collision situation on specific PRACH resource zone for each operator, the load ratio among the operators can be approximately as R_{p,I} which is the load ratio of O_{p,I} and it satisfies (1)

Σₚ₌₁^{P}Σᵢ₌₁^{Np}R_{p,t}−1 (1)

In a determine restrictions step 52, a set of restrictions is determined for wireless devices of a lower priority operator of the multiple core network operators based on the estimated random access load.

In one embodiment, the action is selected for access control based on a predefined mapping table as exemplified in Table 2 below. This is enables the different priorities between different core network operators.

TABLE 2
Example for load-action mapping table

| | Overload | |
|---|---|---|
| Level | Ratio | Cell Barring Action |
| 1 | 0%-12.5% | 50% wireless devices of CND |
| 2 | 12.5%-25% | 100% wireless devices of CND |
| 3 | 25%-37.5% | 100% wireless devices of CND + 25% |
| | | wireless devices of CNC and CNB |
| 4 | 37.5%-50% | 100% wireless devices of CND + 50% |
| | | wireless devices of CNC and CNB |
| 5 | >50% | 100% wireless devices of CND + 75% |
| | | wireless devices of CNC and CNB |
| 6 | >50% | 100% wireless devices of CND + 100% |
| | | wireless devices of CNC and CNB |
| 7 | >50% | 100% wireless devices of CND + 100% |
| | | wireless devices of CNC and CNB + 50% |
| | | wireless devices of CAN |

This mapping table works best when each core network operator has approximately the same load in each situation. Optionally, the mapping table can be also designed based on the long term statistics of a load ratio situation in a particular RAN and/or cell of the RAN.

When there are load estimates available for individual core network operators, the restrictions can be calculated according to the following:

The access barring ratio B_{p,I}(0%-100%) is calculated for each core network operator O_{p,I}, to solve the access attempt collision problem as follows:

Calculate the ratio of the wireless devices from a core network operator whose priority is lower or equal than priority level p as RBₚ=Σⱼ₌ₚ^{p}Σᵢ₌₁^{N}^{ⱼ}R_{j,i};

Find p* that satisfies RB_{p*-1}≦E≦RB_{p*};

The access barring ratio for operator with lower priority than p* is set to be 100% and that with higher priority than p* is set to be 0%, i.e.

$${B}_{p , i} = 0 \% ( p = 1 , 2 , … , {p}^{*} - 1 , i = 1 , 2 , … , {N}_{p} ) ;$$

$${B}_{p , i} = 100 \% ( p = {p}^{*} + 1 , … , P , i = 1 , 2 , … , {N}_{p} ) ;$$

$${B}_{{p}^{*} , i} = \frac{E \cdot {RB}_{{p}^{*} - 1}}{{N}_{{p}^{*}}} ( i = 1 , 2 , … , {N}_{{p}^{*}} ;$$

In a restrict step 54, random access us restricted in the cell according to the set of restrictions.

In one embodiment the restricting random access comprises updating a system information block which is broadcasted in the cell to effect a barring factor for one or more specific core network operators.

FIG. 4B is a flow chart illustrating an embodiment of a method for managing collisions in a cell. The method is similar to the one described with reference to FIG. 4A and only differences to that method will be described here.

After the restrict step 54, there is a conditional load>threshold step 56. If this evaluated to be true, the method returns to the determine restrictions step 52. Otherwise the method ends. The conditional load>threshold step 56 can e.g. estimate the load as described above with reference to the estimate load step 50. Optionally, when the method returns to the determine restrictions step, the overload ratio E (or estimated total load) can be increased by an amount to thereby obtain stricter restrictions compared to the previous iteration. Alternatively, when the mapping table of Table 2 above is used, the level can be increased by one every time the load is greater than the threshold and a new iteration is performed.

FIG. 4C is a flow chart illustrating an embodiment of a method for managing collisions in a cell. The method is similar to the one described with reference to FIG. 4B and only differences to that method will be described here.

In this embodiment, the conditional load>threshold step 56 is performed prior to the determine restrictions step 52. This is to illustrate that the restrictions do not need to be performed when the load is less than (or equal) than the threshold.

In this embodiment, after the restrict step 54, the method returns to the estimate load step 50.

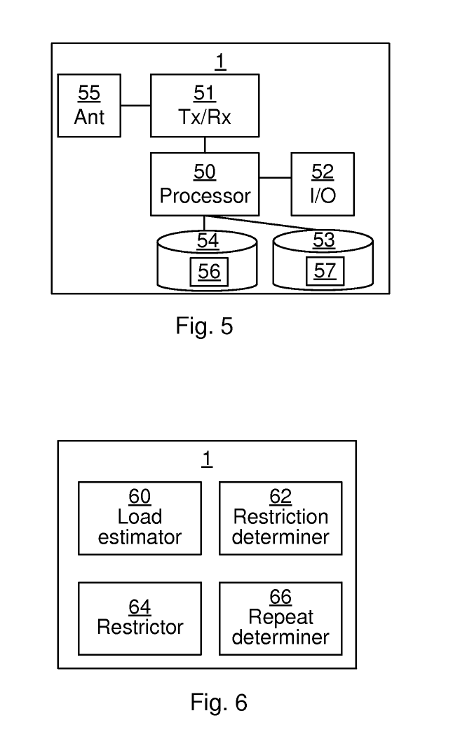

FIG. 5 is a schematic diagram showing some components of the network node of FIG. 1. A processor 50 is provided using any combination of one or more of a suitable central processing unit (CPU), multiprocessor, microcontroller, digital signal processor (DSP), application specific integrated circuit etc., capable of executing software instructions 56 stored in a memory 54, which can thus be a computer program product. The processor 50 can be configured to execute the method described with reference to FIGS. 4A-C above.

The memory 54 can be any combination of read and write memory (RAM) and read only memory (ROM). The memory 54 also comprises persistent storage, which, for example, can be any single one or combination of magnetic memory, optical memory, solid state memory or even remotely mounted memory.

The network node 1 further comprises an I/O interface 52 for communicating with the core networks and optionally with other network nodes.

The network node 1 also comprises one or more transceivers 51, comprising analogue and digital components, and a suitable number of antennas 55 for radio communication with wireless devices within one or more radio cells, optionally using remote radio units and/or sectors. The processor 50 controls the general operation of the network node 1, e.g. by sending control signals to the transceiver 51 and receiving reports from the transceiver 51 of its operation. In one embodiment, the I/O interface 52 is directly connected to the transceiver 51, whereby data to and from the core networks is directly routed between the I/O interface 52 and the transceiver 51.

Other components of the network node 1 are omitted in order not to obscure the concepts presented herein.

FIG. 6 is a schematic diagram showing functional modules of the network node of FIGS. 1 and 5. The modules can be implemented using software instructions such as a computer program executing in the network node 1 and/or using hardware, such as application specific integrated circuits, field programmable gate arrays, discrete logical components, etc. The modules correspond to the steps in the methods illustrated in FIGS. 4A-C.

A load estimator 60 is arranged to estimate a random access load for a cell. This module corresponds to the estimate load step 50 of FIGS. 4A-C.

A restriction determiner 62 is arranged to determine restrictions for wireless devices of zero or more core network operators. This module corresponds to the determine restrictions step 52 of FIGS. 4A-C.

A restrictor 64 is arranged to perform the restriction determined by the restriction determiner 62. This module corresponds to the restrict step 54 of FIGS. 4A-C.

A repeat determiner 66 is arranged to determine whether to repeat one or more of the processing of the other modules. This module corresponds to the conditional load>threshold step of FIGS. 4B-C.

The invention has mainly been described above with reference to a few embodiments. However, as is readily appreciated by a person skilled in the art, other embodiments than the ones disclosed above are equally possible within the scope of the invention, as defined by the appended patent claims.

1-15. (canceled)

16. A method for managing collisions in a cell of a cellular communication network comprising a radio access network shared by a plurality of core network operators, each core network operator being associated with a priority, the method being performed in a network node and comprising the steps of:
estimating a random access load in the cell by considering successful and failed random access attempts by wireless devices during an estimation period in the cell;
determining a set of restrictions for wireless devices of a lower priority operator of the multiple core network operators based on the estimated random access load; and
restricting random access in the cell according to the set of restrictions.

17. The method according to claim 16, further comprising the step, after the step of restricting, of determining whether the random access load is higher than a threshold value, wherein the method is repeated when the random access load is higher than the threshold value, wherein each new iteration of the step of determining a set of restrictions comprises determining a set of restrictions which is stricter compared to the previous iteration.

18. The method according to claim 16, wherein the step of estimating a random access load comprises calculating the sum of a number of successful random access attempts and a failure term, the failure term being calculated as a number of failed random access attempts multiplied by a factor two.

19. The method according to claim 17, wherein the step of estimating a random access load comprises calculating the sum of a number of successful random access attempts and a failure term, the failure term being calculated as a number of failed random access attempts multiplied by a factor two.

20. The method according to claim 16, wherein the step of restricting random access comprises updating a system information block which is broadcasted in the cell.

21. The method according to claim 16, wherein the step of estimating a random access load comprises estimating a random access load associated with each core network operator.

22. The method according to claim 21, wherein the step of estimating comprises detecting random access attempts in random access resources which are assigned to individual ones of the core network operators.

23. The method according to claim 20, further comprising the step, after the step of restricting, of determining whether the random access load is higher than a threshold value, wherein the method is repeated when the random access load is higher than the threshold value, wherein each new iteration of the step of determining a set of restrictions comprises determining a set of restrictions which is stricter compared to the previous iteration; wherein each new iteration involves increasing an estimated total load in the cell.

24. The method according to claim 21, further comprising the step, after the step of restricting, of determining whether the random access load is higher than a threshold value, wherein the method is repeated when the random access load is higher than the threshold value, wherein each new iteration of the step of determining a set of restrictions comprises determining a set of restrictions which is stricter compared to the previous iteration; wherein each new iteration involves increasing an estimated total load in the cell.

25. A network node arranged to manage collisions in a cell of a cellular communication network comprising a radio access network shared by a plurality of core network operators, each core network operator being associated with a priority, the network node comprising:
a processor; and
a memory storing instructions that, when executed by the processor, cause the network node to:
estimate a random access load in the cell by considering successful and failed random access attempts by wireless devices during an estimation period in the cell;
determine a set of restrictions for wireless devices of a lower priority operator of the multiple core network operators based on the estimated random access load; and
restrict random access in the cell according to the set of restrictions.

26. The network node according to claim 25, further comprising instructions to determine whether the random access load is higher than a threshold value, and to repeat the mentioned instructions when the random access load is higher than the threshold value, wherein each new iteration of the instructions to determine a set of restrictions comprises instructions to determine a set of restrictions which is stricter compared to the previous iteration.

27. The network node according to claim 25, wherein the instructions to estimate a random access load comprises instructions to calculate the sum of a number of successful random access attempts and a failure term, the failure term being calculated as a number of failed random access attempts multiplied by a factor two.

28. The network node according to claim 26, wherein the instructions to estimate a random access load comprises instructions to calculate the sum of a number of successful random access attempts and a failure term, the failure term being calculated as a number of failed random access attempts multiplied by a factor two.

29. The network node according to any one of claims 25, wherein the instructions to restrict random access comprises instructions to update a system information block which is broadcasted in the cell.

30. The network node according to any one of claims 25, wherein the instructions to estimate a random access load comprises instructions to estimate a random access load associated for each core network operator.

31. The network node according to claim 30, wherein the instructions to estimate comprises instructions to detect random access attempts in random access resources which are assigned to individual ones of the core network operators.

32. The network node according to claim 29, further comprising instructions to determine whether the random access load is higher than a threshold value, and to repeat the mentioned instructions when the random access load is higher than the threshold value, wherein each new iteration of the instructions to determine a set of restrictions comprises instructions to determine a set of restrictions which is stricter compared to the previous iteration, and instructions to increasing an estimated total load in the cell for each new iteration.

33. The network node according to claim 30, further comprising instructions to determine whether the random access load is higher than a threshold value, and to repeat the mentioned instructions when the random access load is higher than the threshold value, wherein each new iteration of the instructions to determine a set of restrictions comprises instructions to determine a set of restrictions which is stricter compared to the previous iteration, and instructions to increasing an estimated total load in the cell for each new iteration.

34. The network node according to 25, wherein the network node is in the form of a radio base station being associated with the cell.

35. The network node according to 26, wherein the network node is in the form of a radio base station being associated with the cell.
